(19) United States
(12) Patent Application Publication
(10) Pub. No.: US 2007/0290924 A1
(43) Pub. Date: Dec. 20, 2007

(54) Wireless resource monitoring system and method

(75) Inventor: James William McCoy, Plano, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Innerwireless, Inc., Richardson, TX (US)

(21) Appl. No.: 11/300,218

(22) Filed: Dec. 14, 2005

(51) Int. Cl. G01S 3/02; H04B 1/38

(52) U.S. Cl. 342/464; 455/73

(57) ABSTRACT

A wireless resource monitoring system and method utilizes a network of deployed radio elements including at least one master radio, a plurality of beacons, and at least one tag. The beacons are placed at known positions. The master radio, the beacons and the tag are in wireless communication with each other. The tag is attached to the resource that is being monitored. A beacon signal is transmitted by the beacons, which includes the identity of the transmitting beacons. The tag receives the beacon signals and measures the signal strength of the beacon signals. The tag then transmits a tag signal, which includes the identity of the transmitting tag, the measured signal strengths of the beacon signals and the identity of the corresponding beacons. The location of the tag is then determined from the tag signal.

### BACKGROUND OF THE INVENTION

1. Field of the Invention

The invention relates generally to the field of wireless communications. More specifically, the invention relates to a wireless resource monitoring system and method. The invention utilizes a network of deployed radio elements such as master radios, beacons and tags to monitor the location of resources.

2. Description of the Related Art

Presently available wireless systems for monitoring resources, such as Radio Frequency Identification (RFID) systems, are too expensive or too complicated for many ordinary applications. Also, these RFID systems do not measure and report the location of resources throughout a facility. In many applications such as, for example, residential, commercial, and industrial building automation, simple and inexpensive systems are desired.

Many presently available RFID systems use proprietary and complex single purpose hardware and software. Also, RFID systems typically use proprietary protocols and special purpose RF transponders, also known as tags. A typical RFID system includes a location processor connected to a plurality of location transceivers. The location processor may be a computer, such as, for example, a Windows-based PC or a Linux Server. The location processor may be connected to the location transceivers via, for example, a LAN connection or other wired connection. The location transceivers are configured to take measurements and provide the measurements (i.e., data) to the location processor. The location processor typically includes software applications for processing the data. The location processor may be connected to a database to store the computed location information. The location processor may be connected to a LAN connection such that users may query the database and display information via web browser applications software.

Recent RFID systems have attempted to use existing data communications infrastructure and protocols such as, for example, IEEE 802.11 WLAN standards. The WLAN standards do not address the problems associated with proprietary RFID systems, other than to provide their own complex multipurpose protocols. The WLAN standards leave in place all of the typical system elements and the cost associated with their purchase, installation, and ongoing operation. The cost of wired connections to the location transceivers, in this case “access points,” often becomes the dominant economic factor and the complexity of the protocol drives the cost of the tags. Also, since WLAN standards provide a finite maximum communications capacity, the increase in load on this limited communications capacity of the WLAN, as required by typical RFID location systems, increases the complexity of the compromises associated with using the WLAN as the basis for the RFID system. Examples of these compromises include trading consistency and rate of location updates versus the perceived voice quality of a voice-over-IP session, or trading access points optimized for WLAN coverage versus access points optimized for measuring location. Consequently, attempts to develop an economically viable system for resource monitoring have proven to be difficult.

Accordingly, a need exists for an economically viable and less complex wireless system and method for resource monitoring. A need exists for a system and method that consumes less power and does not require proprietary hardware, software, or dedicated wiring to the location transceivers. A need exists for a system and method that is suitable for use in a wide range of applications, such as for example, in-building resource tracking and recovery.

### BRIEF SUMMARY OF THE INVENTION

A wireless resource monitoring system and method utilizes a network of deployed radio elements including at least one master radio, a plurality of beacons, and at least one tag. The beacons are placed at known positions. The master radio, the beacons and the tag are in wireless communication with each other. The tag is attached to, or otherwise associated with, the resource that is being monitored.

A beacon signal is transmitted by the beacons, which includes the identity of the transmitting beacons. The tag receives the beacon signals and measures the signal strength of the beacon signals. The tag then transmits a tag signal, which includes the identity of the transmitting tag, the measured signal strengths of the beacon signals and the identity of the corresponding beacons. The master radio receives the tag signal and forwards the information in the signal to a processor. The beacon-to-tag distances are determined from the measured signal strength values. The locations of the beacons are determined from the beacons' identity. The location of the tag is then determined from the beacon-to-tag distances and the location of the corresponding beacons.

The beacon signal having the highest beacon signal strength value and the corresponding beacon are identified. The highest beacon signal strength value is compared to a predetermined first threshold value. If the highest beacon signal strength value is greater than the predetermined first threshold value, the location of the tag is indicated in relation to the beacon corresponding to the highest beacon signal strength value. Next, the region which includes the beacon corresponding to the highest beacon signal strength value is identified, and the location of the tag is indicated by the region in which the beacon corresponding to the highest beacon signal strength value is located.

If there are a minimum number of measured beacon signal strength values from a contiguous group of beacons having values greater than a second threshold value, the tag's location is calculated using the minimum number of measured beacon signal strength values from the contiguous group of beacons having values greater than the second threshold value. If the measured beacon signal strength values are not from a contiguous group of beacons, the tag's location and an uncertainty value associated with the tag's location are calculated and are displayed. If there is not a minimum number of beacon signal strength values greater than a second threshold value, the tag's location is calculated using the beacon signal strength values adjusted by a weighting factor and an uncertainty value associated with the tag's calculated location is calculated.

### BRIEF DESCRIPTION OF THE DRAWINGS

A better understanding of the present invention can be obtained when the following detailed descriptions of various disclosed embodiments are considered in conjunction with the following drawings, in which:

FIG. 1 illustrates one embodiment of a wireless resource monitoring system.

FIG. 2 illustrates another embodiment of a wireless resource monitoring system.

FIG. 3 illustrates yet another embodiment of a wireless resource monitoring system.

FIGS. 4A and 4B illustrate deployment of beacons inside a building.

FIG. 5 is a block diagram of one embodiment of a location processor.

### DETAILED DESCRIPTION OF THE INVENTIONS

A wireless resource monitoring system and method provides a solution to the problems associated with existing RFID systems. In one embodiment, the wireless resource monitoring system is a radio frequency (RF) resource monitoring system and method. The wireless resource monitoring system and method may be used in many applications such as, for example, resource tracking, asset inventory, resource recovery, and personnel, staff, visitor, and resource management, and can be deployed in a building, a warehouse, or in any other desired location.

In one embodiment, the wireless resource monitoring system and method overcomes the disadvantages associated with using proprietary hardware, software, and protocols by building upon the public communications standard known as the IEEE 802.15.4 standard. The IEEE 802.15.14 standard provides a basis for multi-industry use of common hardware (e.g., silicon chip sets for radios) as well as lower levels of common software and protocols (e.g., physical and media access layers). Utilizing the IEEE 802.15.4 standard instead of the popular IEEE 802.11 standard removes the conflicting requirements of compromising for system performance versus optimizing for WLAN performance.

It is well understood that the location of an object can be determined by taking measurements in relation to the object and three reference points (i.e., known locations). The measurements may be the distances between the object and the three reference points, the angles between the object and the three reference points, or the strengths of incoming signals from the three reference points as measured at the object. Thus, by taking three measurements in relation to the object and three reference points, the location of the object can be calculated. If measurements can be taken between the object and three reference points, the object is said to have visibility to the three reference points.

However, using only three measurements to calculate a location of an object generally results in poor accuracy due to inaccuracy in the measurements and reference points that are not equally spaced around the object. Consequently, the calculated location diverges from the true location. Only when the object to be located is at the center of an equilateral triangle formed by three reference points, do the divergences of the calculated location not arise. Also, using only three measurements to calculate a location may sometimes result in an unbounded inaccuracy. For example, if the object to be located is on the same line as the three reference points and the measurements are angles from the reference point to the object, then the measurements are redundant and the object may be at any distance from the reference points.

In general, as the number of visible reference points (and measurements) increases, the sensitivity to spatial geometry decreases, thus increasing the location accuracy. In one embodiment, the wireless resource monitoring system and method utilizes an increased number of measurements (greater than three) to monitor, track and recover deployed resources with increased accuracy.

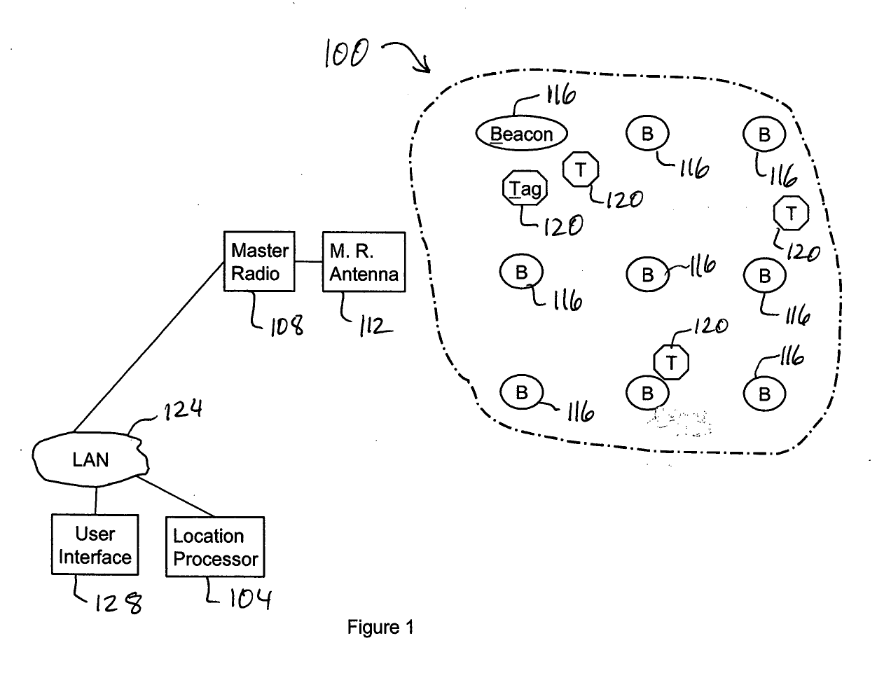

FIG. 1 illustrates a wireless resource monitoring system 100 in accordance with one embodiment of the invention. The system 100 includes a location processor 104 linked to a master radio 108 via, for example, a local area network (LAN) 124. The master radio includes a master radio antenna 112. The master radio 108 is in wireless communication with a plurality of beacons 116 and a plurality of tags 120. The master radio 108, the beacons 116 and the tags 120 are also referred to generally as radio elements or radio nodes.

In FIG. 1, the measuring devices are embodied as the tags 120 and the reference points are embodied as the beacons 116. The tag 120 is a radio transceiver that can be attached to, or otherwise be associated with, a resource that is at an unknown location. The tag 120 can be attached to, or otherwise be associated with, a resource for the purpose of determining the location and identity of the resource. The resource may be a movable object, a person or any item. The beacon 116 is a radio transceiver, which broadcasts its location from a known position (i.e., known location). The beacon 116 is typically affixed at, or attached to, a known position and is generally used for helping measuring devices such as the tags 120 determine their location. The tags 120 take various measurements in relation to the beacons 116. One or more algorithms are applied to the measurements to determine the location of the tags 120. In other embodiments of the invention, the beacons 116 can function as the measuring devices and measure the strength of the signals transmitted by the tags 120.

The location processor 104 may be a computer that receives measurement data from the master radio 108. In one embodiment, the location processor 104 has access to a database of the beacon 116 locations (not shown in FIG. 1) and may execute a software algorithm to calculate the tag 120 locations using the measurements provided by the tags 120 via the master radio 108.

The system 100 also includes one or more user interfaces 128, which are connected to the location processor 104 through the LAN 124. In other embodiments, the user interface 128 can be directly connected to the location processor 104. The user interface 128 may be a computing device, such as, for example, a personal computer. In another embodiment, the location processor 104 may be linked to the user interface 128 through the LAN 124 and the Internet (not shown in FIG. 1). The user interface 128 allows end-users and application processors to gain access to the location processor 104. In another embodiment, the location processor 104 and the user interface 128 can be incorporated into a same device.

The master radio 108, the beacons 116 and the tags 120 are also commonly referred to as radio elements or radio nodes. The radio elements each include a transceiver. The transceiver typically includes one or more antennas, amplifiers, power sources, packaging, and mounting and attachment mechanisms. The components of the transceiver can be tailored to the functional role of the particular radio element.

In operation, the location processor 104 initiates an update of the tags' 120 locations by sending an instruction to the master radio 108. The instruction may include sequence and timing of transmissions by the master radio 108, the beacons 116 and the tags 120. The master radio 108 transmits the instruction to the beacons 116 and the tags 120.

In one embodiment, the identifications of the beacons 116 and their respective location information are stored in the location processor 104. Consider for example, a coverage area that has six beacons (beacons 1-6) installed. The example data related to the six beacons provided below may be stored in the location processor 104. The format of the data provided below is merely exemplary and illustrative only.

{Beacon 1, “Room 703”, x=10 ft, y=10 ft}

{Beacon 2, “Room 704”, x=10 ft, y=40 ft}

{Beacon 3, “Room 705”, x=10 ft, y=70 ft}

{Beacon 4, “Room 706”, x=40 ft, y=10 ft}

{Beacon 5, “Room 707”, x=40 ft, y=40 ft}

{Beacon 6, “Room 708”, x=40 ft, y=70 ft}

In one embodiment, the beacons 116 transmit a beacon signal that includes their identification information (i.e., Beacon 1, Beacon 2, etc.). The beacon signals from the beacons have substantially equal signal strength, i.e., the beacon signals are transmitted by the beacons at substantially the same signal strength.

The tags 120 measure the signal strength of the beacon signals. Since each tag 120 is located at a different distance with respect to the beacons 116, the measured strength of the beacon signals at each tag 120 will vary.

The tags 120 store the measured signal strength of the beacon signals and the identification of the beacons 116 from which the tags 120 received the beacon signal. For example, a tag may store the following data:

{−57 dBm, Beacon 1}

{−55 dBm, Beacon 2}

{−47 dBm, Beacon 3}

{−62 dBm, Beacon 4}

{−59 dBm, Beacon 5}

{−68 dBm, Beacon 6}

The format of the data provided above is merely exemplary and illustrative. The tag 120 transmits a tag signal that includes the stored data and a tag 120 identification information. The master radio 108 receives the tag signal and forwards the information in the tag signal to the location processor 104. The location processor 104 thus is provided with the following information: the location of the beacons 116, the signal strength of the beacon signals measured at the tag 120, the identity of the transmitting beacons 116 and the identity of the tag 120. The location processor 104 executes an algorithm to calculate the location of the tag 120 using the information provided by the tag 120.

The location processor 104 updates the location information of the tags 120 by storing the updated location information in a memory (e.g., RAM, hard drive or any other storage device). Upon request from a user interface 128, the location processor 104 can provide tag identification and location information to the user interface 128. The location processor 104 can provide location information for a specific tag 120, a group of tags 120, or all tags 120 to the user interface 128. The user interface 128 may retrieve the location information at any time independent of the location update initiated by the location processor 104.

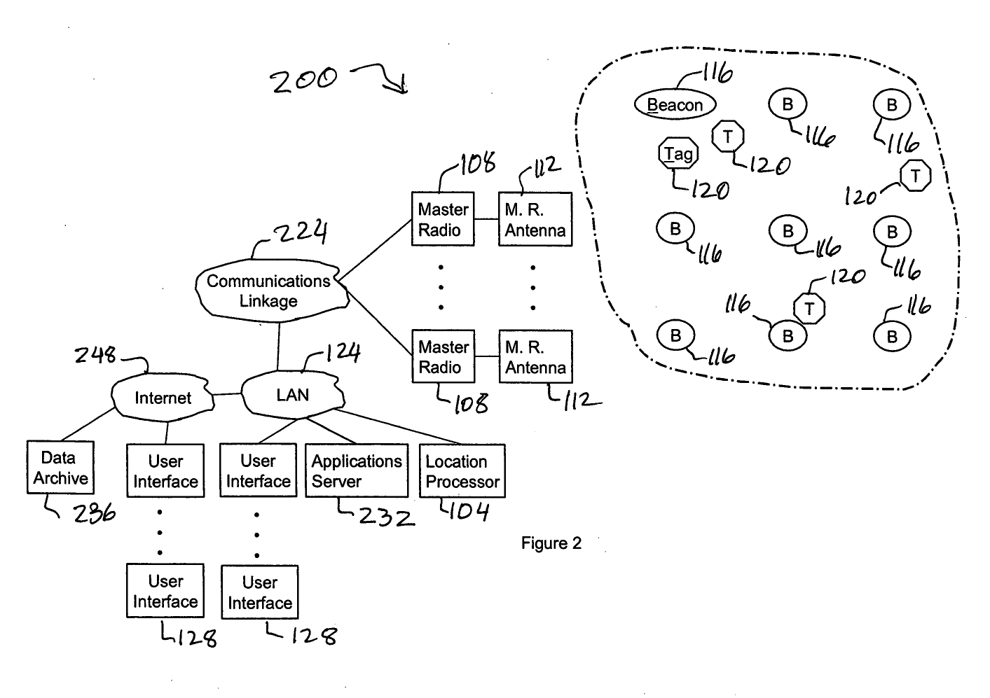

FIG. 2 illustrates a wireless resource monitoring system 200 according to another embodiment. The system 200 includes a location processor 104 connected to a plurality of master radios 108 via a LAN 124. Each master radio 108 includes a master radio antenna 112. The master radios 108 are in wireless communication with a plurality of beacons 116 and tags 120.

The system 200 further includes a communications link 224 between the master radios 108 and the LAN 124. The communications link 224 can be a two-way data communications link such as a fiber, free space optical, wireless point-to-point radio, or wireless point-to-multi-point radio link. The communications link 224 provides the necessary information flow between the master radios 108 and devices connected to the LAN 124.

An applications server 232 is linked to the location processor 104 through the LAN 124. The applications server 232 allows a plurality of user interfaces 128, a data archive 236, and other enterprise application processors (not shown in FIG. 2) to gain access to the information in the location processor 104. The data archive 236 provides file backup and restoration for the location processor 104. The user interfaces 128 can also gain access to the location processor 104 via the Internet 248 and the LAN 124.

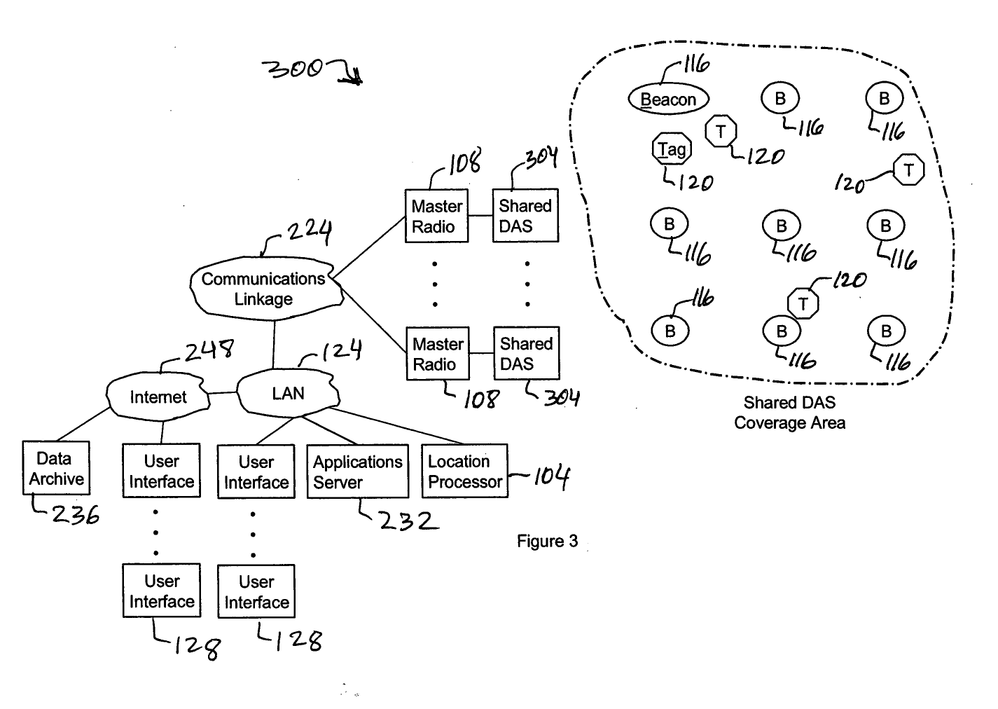

FIG. 3 illustrates a wireless resource monitoring system 300 according to another embodiment. The system 300 is similar to the one illustrated in FIG. 2 except that each master radio 108 includes a distributed antenna system 304. The distributed antenna system 304 provides more uniform signal coverage from and between the master radio 108, the beacons 116, and the tags 120. In some areas such as, for example, a building, a distributed antenna system 304 may be required to ensure that the master radio 108 provides coverage for the tags 120 deployed in rooms separated by walls that obstruct signal propagation from a single master radio antenna. Those skilled in the art will recognize that the multiplicity of radiating elements in a distributed antenna system allows the signal coverage to be established closer to the beacons 116 and tags 120 and thus suffer less attenuation, reflections, or blockage.

The distributed antenna systems 304 may be dedicated to the wireless resource monitoring system 300 because the floor plan and construction of the rooms in a building obstructs signal propagation from a single master radio antenna 108 as in FIG. 2. Also the distributed antenna 304 system may be used because it is shared with other RF services such as, for example, a wireless LAN (WLAN), a cellular/PCS service, paging network, or a two-way radio system. The present invention allows a wide range of embodiments ranging from single or multiple master radios each using a master radio antenna, to multiple master radios some using master radio antennas and others using distributed antenna systems, to single or multiple master radios each using a distributed antenna system.

In one embodiment of the invention, the master radio 108 the beacons 116 and the tags 120 communicate with each other using the IEEE 802.15.4 standard. In another embodiment the master radio 108 the beacons 116 and the tags 120 communicate using the ZigBee standard (also known as the Zigbee protocol), which runs on top of the IEEE 802.15.4 standard. The IEEE 802.15.4 standard allows the implementation of a low-cost, single chip radio transceiver for the beacons 116 and the tags 120. The ZigBee protocol allows the implementation of a low-cost wireless mesh network. In other embodiments, other suitable wireless communication standards or protocols including high level communication standards or protocols can be utilized for communication among the master radio 108 the beacons 116 and the tags 120. The terms standard and protocol are used interchangeably.

In one embodiment of the invention, the master radio 108 includes a master radio antenna 112 (or a distributed antenna systems 304) with sufficient coverage area such that the beacons 116 and the tags 120 have at least one direct communications path to the master radio 108. An assurance of a direct communications path to the master radio 108 allows the beacons 116 and the tags 120 to be configured to spend a significant percentage of time in a very low power consumption or “sleep” mode enhancing the practicality of battery powered beacons 116 and tags 120. Otherwise, the beacons 116 and possibly the tags 120 would remain in an “active” receive and transmit mode in order to relay indirect communications of other beacons 116 and tags 120 to the master radio 108 and vice versa. For example, one embodiment of a wireless resource monitoring system with assured direct communications paths to all beacons 116 and tags 120 could spend less than one percent (1%) of its time in an “active” receive and transmit mode consuming approximately five milliwatts (5 mW) of power with the remaining ninety-nine percent (99%) in a very low power consumption, less than 5 microwatts (5 μW), “sleep” mode. This one-thousand to one (1000:1) reduction in power consumption allows a practical multi-year battery lifetimes. Practical battery powered beacons 116 and tags 120 improve system cost effectiveness because installation of wiring to power each beacon 116 could otherwise dominate the total system cost.

While different embodiments are shown in FIGS. 1, 2 and 3, the exact configuration of the system deployed will vary depending on the complexity and scale of the deployment and the characteristics of the location of the deployment.

In one embodiment, at least one master radio 108 is deployed per logical physical space. A logical physical space may be, for example, a floor of a high-rise office, a wing of a hospital, or a warehouse of a small manufacturing plant. Multiple or redundant master radios 108 per logical physical space may be deployed depending on the criticality of the applications. For example, in a hospital, redundant master radios 108 may be deployed per logical physical space to provide backup in the event of a failure. Also, multiple master radios 108 may be deployed to scale the system to cover the entirety of a building (e.g., high-rise, hospital, plant) or the entirety of a campus.

A single location processor 104 is generally required per deployment and may serve many master radios 108 beacons 116 and tags 120. However, multiple or redundant location processors 104 may be deployed depending on the criticality of the applications or other design criteria.

In one embodiment of the invention, redundant master radios 108 are deployed per coverage area. For example, in one coverage area a first master radio 108 may function as a full transceiver having transmit and receive functions and a second master radio 108 may function as a receive-only device. If a failure of the first master radio 108 is detected, the redundant master radio becomes a full transceiver.

When two master radios 108 are deployed, each in a different location in a room, partially or largely redundant, but not completely redundant, coverage is achieved. Consequently, if one master radio 108 is unable to communicate with a tag 120 in the room (because the tag 120 may be obstructed by a person or an object), the second master radio 108 may be able to communicate with the tag, thereby increasing the probability or likelihood of coverage. For complete redundancy of coverage the two master radios 108 must be placed in the same approximate location to provide same antenna coverage. Thus, the application of redundant master radio 108 provides failure backup and increased probability of coverage.

The deployment of redundant master radios 108 necessitates that the location processor 104 accept partially or largely redundant data. As will be described later, a correlation engine or data filter 508 can be used to rationalize the raw data into a single unified data set to present to a location algorithm module.

The functionality of the application server 232 can be incorporated into the location processor 104. A separate application server 232 can be utilized when there is a large number of user interfaces 128 or there is a large number of external applications processor interfaces (not shown in the Figures). The external applications processor interfaces generally access data from the wireless resource monitoring system 100, 200, 300. If only a small number of external processors and a small number of user interfaces 128 need to access the location processor 104 they can directly access the location processor 104. However, if a large number of external processors and user interfaces 128 need to access the location processor 104 an application server 232 can be used so that the location processor 104's performance is not compromised. A plurality of applications servers 232 can be deployed if redundancy is required because of the particular application.

In many instances the physical demarcation of a building is also the logical constraint on a tag 120's calculated location. In one embodiment, the calculated location of a tag 120 is constrained to that which is plausible as indicated by data from other sources (e.g., physical demarcation, prior measurements, etc.). For example, if the result of a calculation indicates that a tag 120 is outside the building when the tag 120 should logically be inside the building then that result is discarded as being invalid and an alternate result that is plausible is accepted.

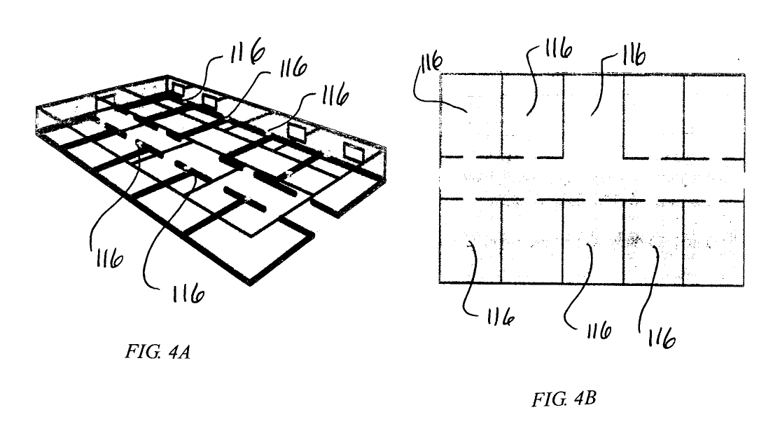

FIGS. 4A and 4B illustrate deployment of the beacons 116 inside a building. FIGS. 4A and 4B are isometric and plan views, respectively, of a floor showing the deployment of the beacons 116. The floor is divided into several rooms and a hallway, which are the physical demarcations of the floor. In one embodiment, a beacon 116 is deployed in each room. In many instances, a tag 120 may be located in a particular room. The tag 120's location is first determined using the methods described before (i.e., by measuring the strength of the beacon signals). The tag 120's location can be determined in X and Y coordinates and the results can be forced to be within the room in which the beacon 116 corresponding to the strongest beacon signal is located. Consequently, a tag 120's location can be indicated by the room in which the beacon 116 corresponding to the strongest beacon signal is located.

In some instances, a tag 120 may be located in a hallway or a large room. In those instances, it may be insufficient to simply indicate the location of the tag 120 by identifying the hallway or the large room. It may be desirable to indicate the location of the tag more precisely by, for example, indicating that the tag 120 is located at the east end, the west end, or at the center of the hallway. In order to identify the tag 120's location more precisely in a hallway, multiple beacons may be deployed in a hallway in a nominal linear spacing or grid fashion as shown in FIGS. 4A and 4B. Since the beacons 116 locations are known (e.g., east end or center of a hallway), the tag 120's location can be determined in X and Y coordinates and the results can be forced to be within the coverage area of the nearest beacon 116 or in some other manner in relation to the nearest beacon 116. Thus the multiple beacons 116 provide a constraint on location accuracy. The adjacent beacons 116 (i.e., beacons 116 in adjacent rooms) are also available for inclusion in the measurements and calculation of the location.

In one embodiment, the antenna for the beacon 116 is chosen to produce a lower hemispherical pattern. Those skilled in the art will recognize that examples of such antenna choices would include, but not be limited to, vertically oriented mono-poles, horizontally oriented patches, or similar point-source radiators. Those skilled in the art will further recognize that multipath signal fading introduces variability to both the signal strength and the polarization of the RF signal. The affects due to the variability in the signal strength and variability in the polarization are addressed by the selection of an antenna having polarization diversity or circular polarization. Multipath signal strength fading is also addressed by the selection of an antenna having spatial diversity.

In one embodiment, the tags 120 are affixed to (or otherwise positioned on) an upward facing surface of an object (e.g., an asset) to which they are attached. As a result, a nominally clear line-of-sight RF propagation path is ensured from the tag 120 to the nearest beacon 116. The antenna type for the tag 120 is chosen to produce an upper hemispherical pattern to allow the tag 120 to communicate with the beacon 116 that is affixed in (or otherwise located in) the ceiling, wall or other desired locations. If it is not possible to attach the tag 120 on an upward facing surface so that an upper hemispherical pattern cannot be achieved, an antenna that generates a spherical pattern is chosen. Those skilled in the art will recognize that examples of such antenna choices would include, but not be limited to, vertically oriented mono-poles (spherical pattern), horizontally oriented patches (upper hemispherical pattern), or any similar point-source radiator (spherical pattern). As discussed before, multipath fading introduces variability to both the signal strength and the polarization of the RF signal. These affects are addressed by selection of an antenna that provides polarization diversity.

In one embodiment, the radio elements (i.e., master radio, beacons, and tags) communicate with each other using the IEEE 802.15.4 standard. The master radio 108, beacons 116, and tags 120 may also communicate using other wireless communication protocols or a custom protocol layer, which provide the sequence and content of transmission from the radio elements. The radio elements can also communicate using a standardized high level wireless communication protocol, such as the ZigBee standard protocol layer, or a combination of ZigBee standard protocol layer and other protocols, which runs on top of the IEEE 802.15.4 standard. The IEEE 802.15.14 standard and the ZigBee standard are well known to those skilled in the art.

The master radio 108, upon a command from the location processor 104, transmits a message to the beacons 116 and the tags 120 within the master radio 108's coverage area to initiate an update of the measurements for location processing. Since the master radio 108 is in wireless communication with the beacons 116 and the tags 120, the transmissions among the master radio 108, the beacons 116 and the tags 120 are RF transmission or other type of wireless transmission. The transmissions between the master radio 108 and the location processor 104 is a data transmission via wireline, fiber optic or other communication link, including wireless links.

In one embodiment, the master radio 108 remains active at all times (e.g., does not utilize low-power sleep modes), such that the master radio 108 can facilitate both regularly scheduled and asynchronous communications. Regularly scheduled communications occur when the tags 120 and the beacons 116 transmit in accordance with a schedule provided by the adopted communications protocol. Asynchronous communications occur if, for example, a tag 120 is tampered with or the master radio 108 orders the tags 120 to transmit. Also asynchronous communications may occur when the master radio 108 communicates with other wireless devices such as, for example, a battery operated wireless thermostat, a wireless remote controller for the lights and appliances and other devices running the same protocol.

In one embodiment, the wireless resource monitoring system includes a master radio antenna 112 and/or a distributed antenna system 304 with sufficient coverage area such that the beacons 116 and the tags 120 have at least one direct communications path to the master radio 108. The master radio antenna pattern can be optimized to ensure coverage for the beacons 116 and the tags 120 in a given coverage area.

In one embodiment, the location processor 104 can be embodied in a commercially available computer suitable for high reliability applications. The applications server 232 and the data archive 236 may also be embodied in a commercially available computer. As previously noted, when the application server 232 and data archive 236 are absent, their functions may be combined with the functions of the location processor 104. When the location processor 104, the application server 232, and the data archive 236 are all present in the system, each can be optimized for its respective primary function, i.e., the location processor 104 can be optimized for CPU processing performance, the application server 232 can be optimized for multi session input-output bandwidth, and the data archive 236 can be optimized for storage.

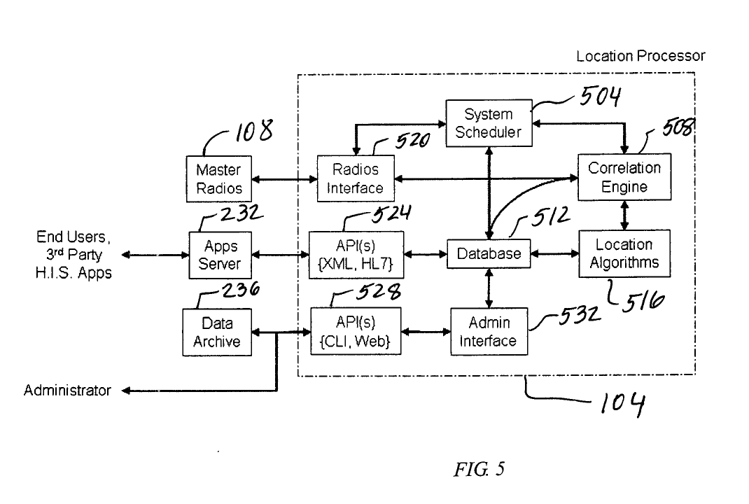

FIG. 5 is a block diagram of a location processor 104 in accordance with one embodiment of the invention. The location processor 104 includes a system scheduler 504, which provides the timing and sequence of activities (e.g., transmission) of the beacons 116, the tags 120 and the master radio 108. The system scheduler 504 may be implemented as software or hardware.

In one embodiment, the system scheduler 504 initiates a location update by instructing the master radio 108 to broadcast a message containing the sequence in which the beacons 116 are to execute transmissions to the tags 120, and the sequence in which specific tags 120 are to respond with their measurements. If there is a multiplicity of master radios 108, the system scheduler 504 instructs the assigned master radios 108 their transmission sequence.

The location processor 104 can include a correlation engine 508. The correlation engine 508 may be a data filter (or equivalent thereof), which receives multiple sets of data, discards any duplicate or redundant records, and generates a single unified set of data. When a multiplicity of master radios 108 are deployed, multiple sets of partially redundant data may be provided by the master radios 108 to the location processor 104. The correlation engine 508 processes the data, and provides a single set of data to an internal database 512 and a location algorithm module 516. The location algorithm module 516 executes one or more algorithms to calculate the current location of the tags 120 using the data. The internal database 512 is used to store the measurements provided by the tags 120 and the beacons 116, and also to store the current calculated locations.

The location processor 104 can also include a radio interface 520, which may be implemented as hardware or software. The radio interface 520 formats raw data received from the master radio 108 and also formats messages from the system scheduler 504 intended for the master radio 108.

In one embodiment, the location processor 104 can include one or more APIs. As shown in FIG. 5, a XML API 524 allows end-users to interact with the location processor 104 to retrieve location of assets. A Web API 528 allows the data archive to access the location processor 104 for data backup. Other APIs not shown in FIG. 5 can be added as required by the specific application. For example, a HL7 API (not shown in FIG. 5) can be included that allows third party healthcare application to interact with the location processor 104. A CLI API (not shown in FIG. 5)) can be included as an Administrator's command line interface used for provisioning and configuration of the location processor 104 via an admin interface 532.

As discussed before, the location algorithm module 516 calculates the location of the tags 120. Data provided by a single tag 120 is ranked based on the strength of the beacon signals. The highest (i.e., strongest) beacon signal and the corresponding beacon 116 are identified. The highest (i.e., strongest) beacon signal is then compared to a predetermined threshold value k1. If the highest beacon signal exceeds the threshold value k1, the tag location is determined to be the area (e.g., room) in which the corresponding beacon 116 (i.e., the beacon 116 that transmitted the beacon signal having the highest signal strength) is located.

Consider, for example, that the data provided by a particular tag 120 includes measurements of beacon signal strength from beacons 1, 2, 3, 4, 5, and 6 with respective values of −66 dBm, −61 dBm, −47 dBm, −67 dBm, −63 dBm, and −59 dBm. Also, assume k1=−50 dBm. The k1 value can be determined from the expected signal strength from a beacon 116 in a typical size room to an unobstructed tag 120 in that same typical size room (or other area where the beacon 116 is located). After sorting the data based on signal strength, it is determined by the location processor 104 that the highest beacon signal strength is −47 dBm and the corresponding beacon is Beacon 3. Since the highest beacon signal strength (−47 dBm) is greater than k1 (−50 dBm), the tag 120's location is determined to be the area (room) in which Beacon 3 is located (e.g., Room 705). Since the tag 120 location can be indicated by a room number, the tag location can be sent, for example, to a simple text only device such as a pager (not shown in FIG. 5). The tag 120 location can also be sent, via a voice synthesis processor, to a wireless or wireline phone (not shown in FIG. 5). The foregoing calculation can be repeated for a plurality of tags 120 for which data is available, and the area locations of the tags 120 are determined.

Next, the locations of the tags 120 are calculated in a linear X, Y coordinate system using conventional techniques. The tags 120's measurements of beacon signal strength are converted into distances and used with the known beacon locations to estimate the tag 120's location. Since the highest signal strength beacon, for each tag, was greater than k1, the estimated tag locations are forced to be within the boundaries of the assigned rooms in which the beacons 116 are installed. Thus the final results may also be graphically displayed as X, Y points on PCs and other user terminals.

If the highest beacon signal strength is not greater than k1, but there are a sufficient number of beacon signal strength measurements (at least 5 or other predetermined number to insure a high probability that the geometry between beacons 116 and the tag 120 has minimal geometric dilution of precision) with signal strength greater than k2, where k2<k1 (k2 can be determined based on the expected signal strength from a beacon in a typical adjacent room to an unobstructed tag in an adjoining room), and the measurements are from a known contiguous or adjacent group of beacons 116, then the tag 120s' location is first calculated using triangulation techniques. Then the tag 120s' calculated locations (e.g., in X, Y coordinates) are then associated with the areas (rooms) whose boundaries of the room includes the calculated location. This allows both X, Y coordinate locations and area (room) locations to be represented in graphical and textual manner for the condition where tags 120 do not measure a beacon signal strength greater than k1.

Consider, for example, that the data associated with Tag 37 includes measurements of beacon signal strength from contiguous or adjacent beacons 1, 2, 3, 4, 5, and 6 with respective values of −67 dBm, −62 dBm, −52 dBm, −68 dBm, −64 dBm, and −61 dBm. Also assume k2=−69 dBm. Therefore, Tag 37 has no measurement greater than k1 and at least 5 measurements with values greater than k2. The measured beacon signal strengths correspond to beacon-to-tag distances of 70.4, 40.6, 12.3, 78.4, 53.4, and 36.7 feet respectively. These beacon-to-tag distances along with the locations of the beacons are then used to calculate the tag 120's position in X, Y coordinates. The tag 120's location in X, Y coordinates is calculated to be {80 ft., 5 ft.} relative to a known location designated as {0, 0} and then associated with the room that contains that X, Y point (i.e., Room 705 is bounded by the four X, Y coordinate pairs, expressed in feet, of {0, 60}, {0, 90}, {30, 60}, and {30, 90} thus the tag is in Room 705). The method of converting a signal strength measurement to a distance is well known in the art and thus will not be described here. Likewise, the method of determining a tag 120's position in X, Y coordinates from the beacon-to-tag distances is also well known in the art and will not be described here. The tag 120's location can also be expressed in other units such as meters.

The calculated tag 120 location may be displayed graphically on PCs or other user terminals. The tag 120 location can be sent to, for example, a simple text only device such as a pager. The tag 120 location can also be sent, via a voice synthesis processor (not shown in FIG. 5), to a wireless or wireline phone (not shown in FIG. 5).

There may be a scenario where the beacon signal strength measurements are not from a contiguous or adjacent group of beacons 116, or some of the measurements may be corrupted or inaccurate. For example, a cart may move between the line of path between a tag 120 and a beacon 116, causing the tag 120 not to be able to measure, or to inaccurately measure, the strength of the signal transmitted by that beacon 116. If the beacon signal strength measurements are not from a contiguous or adjacent group of beacons 116 or contain inaccuracies, then a confidence level, which is a mathematical estimate of the possible magnitude of error in the location, can be calculated. In one embodiment, the confidence level, which represents the error or uncertainty, may be displayed as a circle around the location in X, Y coordinates or in some other manner. In the proceeding example, assume that Tag 37 measured Beacon 6 as −67 dBm (instead of −61 dBm). This will result in an inaccurate beacon-to-tag distance calculation of 70.4 feet being used in the triangulation calculation (instead of the correct 36.7 feet value). If a root-mean-square (RMS) technique is used to estimate the radius of the uncertainty circle around the tag 120's calculated location, the example uncertainty would be 2.4 feet. It will be obvious to those skilled in the art that other techniques can be used to estimate the radius of the uncertainty. The calculated location of the tag 120 in X, Y coordinates and the confidence level may be graphically displayed on PCs and other user terminals. The calculated location can sent to, for example, a simple text only device such as a pager, or via a voice synthesis processor, to a wireless or wireline phone (not shown in FIG. 5).

There may be another scenario where an insufficient number (i.e., less than 5 or other predetermined number) of measurements with beacon signal strength greater than k2 are available for calculation of the tag 120's location. If there is not a minimum number of beacon signal strength values having values greater than k2, i.e., the second threshold value, the tag 120's location is calculated using the beacon-to-tag distance measurements. Then the uncertainty value associated with the calculated location is calculated. If the uncertainty value is larger than a maximum acceptable uncertainty value, the beacon-to-tag distances are adjusted and the tag 120's location is re-calculated using the adjusted beacon-to-tag distances. The foregoing steps can be repeated until the uncertainty value is less than the maximum acceptable uncertainty value. The maximum acceptable uncertainty value may be a predetermined value obtained through calculation or estimation.

Consider, for example, that the data associated with Tag 37 includes measurements of beacon signal strength from beacons 1, 2, 3, 4, 5, and 6 with respective values of −77 dBm, −62 dBm, −52 dBm, −78 dBm, −64 dBm, and −61 dBm. Assume k2=−69 dBm. In this scenario, all available measurements are used in the calculation but are weighted based on their actual signal strength. In this example the measured beacon signal strengths correspond to beacon-to-tag distances of 236.2, 40.6, 12.3, 248.6, 53.4, and 36.7 feet respectively. The amount that each calculated distance, beginning with the strongest signal and progressing in order to the weakest, is allowed to influence the final location result is proportional to signal strength. The beacon-to-tag distance associated with Beacon 3 (12.3 feet) is used in the triangulation calculation with a weighting of 1:1 while the distance associated with Beacon 6 (36.7 feet) is used with a weighting of 1:8 (−52 dBm-−61 dBm=9 dB or one-eighth), and finally Beacon 4 (248.6 feet) is used with a weighting of 1:40 (−52 dBm-−78 dBm=16 dB or one-fortieth). Thus, in this example, Beacon 3 is allowed the greatest influence on the triangulation calculation, then Beacon 6, and finally Beacon 4 is allowed to influence the result minimally. In this situation, the large calculated uncertainty (97.0 feet) may dictate that the tag 120 location be indicated in a more general description of the area instead of a particular room number, even though the calculated tag X, Y location in this example remains relatively accurate at coordinates {82 ft., 7 ft.}. For example, the tag 120 location may be described in as 7th floor North wing or 7th floor Northeast quadrant instead of Room 705.

In one embodiment of the wireless resource monitoring system, the beacons 116 act as the measuring devices. Accordingly, the tag 120 transmits a tag signal that includes the identity of the transmitting tag. The beacons 116 receive the tag signal and measure the signal strength of the tag signal. The beacons 116 transmit a beacon signal that includes the identity of the beacons, the measured signal strength of the tag signal and identity of the tag 120. The master radio 108 receives the beacon signal and provides the information in the beacon signal to the location processor. The location processor determines the location of the tag using the information in the beacon signal.

While certain exemplary embodiments have been described in detail and shown in the accompanying drawings, it is to be understood that such embodiments are merely illustrative of and not restrictive on the broad invention. Other embodiments of the invention may be devised without departing from the basic scope thereof, which is determined by the claims that follow. By way of example, and not limitation, the specific components utilized may be replaced by known equivalents or other arrangements of components which function similarly and provide substantially the same result.

We claim:

1. A method for determining the location of a tag in a wireless network having at least one master radio, a plurality of beacons, and at least one tag, the beacons being located at known positions, the master radio, the beacons and the tag being in wireless communication with each other, the method comprising:
transmitting, by the beacons, a beacon signal including the identity of the transmitting beacons;
receiving the beacon signals at the tag and measuring an attribute of the beacon signals;
transmitting, by the tag, a tag signal including identity of the transmitting tag, the measured attribute of the beacon signals and the identity of the beacons corresponding to the beacon signals;
receiving the tag signal at the master radio; and
determining the location of the tag from the tag signal.

2. The method according to claim 1, wherein the attribute is a signal strength of the beacon signals.

3. The method according to claim 2, further comprising:
identifying the location of the beacons from the beacons' identity;
determining beacon-to-tag distances from the measured signal strengths; and
determining a location of the tag from the beacon-to-tag distances and the location of the corresponding beacons.

4. The method according to claim 1, further comprising:
identifying the beacon signal having the highest beacon signal strength value and identifying the corresponding beacon;
comparing the highest beacon signal strength value to a predetermined first threshold value; and
indicating the location of the tag in relation to the beacon corresponding to the highest beacon signal strength value if the highest beacon signal strength value is greater than the first threshold value.

5. The method according to claim 2, further comprising:
identifying a region in which the beacon corresponding to the highest beacon signal strength value is located; and
indicating the location of the tag by the region in which the beacon corresponding to the highest beacon signal strength value is located.

6. The method according to claim 5, further comprising indicating the location of the tag with respect to a room in which the beacon corresponding to the highest beacon signal strength value is located.

7. The method according to claim 1, further comprising:
determining if more than a predetermined minimum number of measured beacon signal strength values from a contiguous group of beacons have values greater than a second predetermined threshold value; and
calculating the location of the tag using the beacon-to-tag distances corresponding to the minimum number of measured beacon signal strength values from the contiguous group of beacons having values greater than the second threshold value.

8. The method according to claim 7, wherein the contiguous groups of beacons are an adjacent group of beacons.

9. The method according to claim 7, further comprising:
identifying a region which includes the calculated location; and
indicating the location of the tag by the region.

10. The method according to claim 9, wherein the region is a room in a building.

11. The method according to claim 1, further comprising:
calculating the location of the tag if the measured beacon signal strength values from a non-contiguous group of beacons;
calculating an uncertainty value associated with the calculated location of the tag; and
displaying the calculated location of the tag and the uncertainty value.

12. The method according to claim 1, further comprising:
calculating the location of the tag if the measured beacon signal strength values include inaccuracies;
calculating an uncertainty value associated with the calculated location of the tag; and
displaying the calculated location of the tag and the uncertainty value.

13. The method according to claim 1, further comprising:
adjusting the calculated beacon-to-tag distances based on the measured beacon signal strength values if a fewer than a minimum number of beacon signal strength values have values greater than a second threshold value;
calculating the location of the tag using the adjusted beacon-to-tag distances;
calculating an uncertainty value associated with the tag's calculated location; and
displaying the calculated location of the tag and the uncertainty value.

14. The method according to claim 1, further comprising:
calculating the location of the tag using the beacon-to-tag distance measurements if fewer than a minimum number of beacon signal strength values have values greater than a second threshold value;
calculating an uncertainty value associated with the calculated location;
adjusting the beacon-to-tag distances if the uncertainty value is larger than a maximum acceptable uncertainty value; and
re-calculating the location of the tag by re-adjusting the adjusted beacon-to-tag distances until the uncertainty value is less than the maximum acceptable uncertainty value.

15. The method according to claim 1, wherein the master radio is a radio transceiver.

16. The method according to claim 1, wherein the beacon is a radio transceiver.

17. The method according to claim 1, wherein the tag is a radio transceiver.

18. The method according to claim 1, further comprising attaching the tag to a resource.

19. The method according to claim 1, further comprising transmitting the beacon signals at predetermined time intervals.

20. The method according to claim 1, further comprising transmitting the tag signals at predetermined time intervals.

21. The method according to claim 1, further comprising transmitting the beacon signals in response to a request from the master radio.

22. The method according to claim 1, further comprising transmitting the tag signal in response to a request from the master radio.

23. The method according to claim 1, wherein the master radio, the beacons and the tag communicate using a wireless communication standard.

24. The method according to claim 1, wherein the master radio, the beacons and the tags communicate using a high level communication protocol.

25. The method according to claim 1, wherein the master radio is coupled to an antenna.

26. The method according to claim 1, wherein the master radio is coupled to a distributed antenna system.

27. The method according to claim 1, wherein the tag is powered by a battery.

28. The method according to claim 1, wherein the beacon is powered by a battery.

29. A method for determining the location of a resource deployed in a building, the method utilizing a wireless network having at least one master radio, a plurality of beacons and at least one tag being in wireless communication with each other, the tag being associated with the resource, the method comprising:
deploying the plurality of beacons at known positions in the building;
transmitting, by the beacons, a beacon signal including the identity of the transmitting beacons;
receiving the beacon signals at the tag and measuring the signal strength of the beacon signals;
transmitting, by the tag, a tag signal including identity of the transmitting tag, the measured signal strengths of the beacon signals and the identity of the beacons corresponding to the beacon signals;
receiving the tag signal at the master radio;
identifying a location of the beacons from the beacons' identity;
determining beacon-to-tag distances from the measured signal strength values; and
determining a location of the tag from the beacon-to-tag distances and the location of the corresponding beacons.

30. The method according to claim 29, further comprising:
identifying the beacon signal having a highest beacon signal strength value and identifying the beacon corresponding to the highest beacon signal strength value;
comparing the highest beacon signal strength value to a predetermined first threshold value; and
indicating the location of the tag in relation to the beacon corresponding to the highest beacon signal strength value if the highest beacon signal strength value is greater than the first threshold value.

31. The method according to claim 30, further comprising:
identifying a region of the building in which the beacon corresponding to the highest beacon signal strength value is located; and
indicating the location of the tag by the region in which the beacon corresponding to the highest beacon signal strength value is located.

32. The method according to claim 31, further comprising indicating the location of the tag with respect to a room in the building in which the beacon corresponding to the highest beacon signal strength value is located.

33. The method according to claim 29, further comprising:
determining if a minimum number of measured beacon signal strength values from a contiguous group of beacons have values greater than a second threshold value; and
calculating the location of the tag using the beacon-to-tag distances corresponding to the minimum number of measured beacon signal strength values from a contiguous group of beacons having values greater than the second threshold value.

34. The method according to claim 33, further comprising:
identifying a region which includes the calculated location; and
indicating the location of the tag by the region.

35. The method according to claim 31, wherein the region is a room in the building.

36. The method according to claim 29, further comprising:
calculating the location of the tag if the measured beacon signal strength values are from a non-contiguous group of beacons;
calculating an uncertainty value associated with the calculated location of the tag; and
displaying the calculated location of the tag and the uncertainty value.

37. The method according to claim 29, further comprising:
calculating the location of the tag if the measured beacon signal strength values include inaccuracies;
calculating an uncertainty value associated with the calculated location of the tag; and
displaying the calculated location of the tag and the uncertainty value.

38. The method according to claim 29, further comprising:
adjusting the calculated beacon-to-tag distances based on the measured beacon signal strength values if fewer than a minimum number of beacon signal strength values have values greater than a second threshold value;
calculating the location of the tag using the adjusted beacon-to-tag distances;
calculating an uncertainty value associated with the calculated location of the tag; and
displaying the calculated location of the tag and the uncertainty value.

39. The method according to claim 29, further comprising:
calculating the location of the tag using the beacon-to-tag distance measurements if fewer than a minimum number of beacon signal strength values have values greater than a second predetermined threshold value;
calculating an uncertainty value associated with the calculated location of the tag;
adjusting the beacon-to-tag distances if the uncertainty value is larger than a maximum acceptable uncertainty value; and
re-calculating the location of the tag by re-adjusting the adjusted beacon-to-tag distances until the uncertainty value is less than the maximum acceptable uncertainty value.

40. The method according to claim 29, further comprising deploying a plurality of beacons in a selected manner in a large room or a hallway.

41. The method according to claim 29, further comprising deploying at least one beacon in each room in the building.

42. The method according to claim 29 wherein the master radio is a radio transceiver.

43. The method according to claim 29 wherein the beacon is a radio transceiver.

44. The method according to claim 29 wherein the tag is a radio transceiver.

45. The method according to claim 29, further comprising:
transmitting the tag signal including the identity of the transmitting tag, the measured signal strengths of the beacon signals and the identity of the beacons corresponding to the beacon signals to a processor; and
determining the location of the tag at the processor using the measured signal strengths of the beacon signals and the location of the beacons corresponding to the beacon signals.

46. The method according to claim 29, further comprising transmitting the beacon signals at predetermined time intervals.

47. The method according to claim 29, further comprising transmitting the tag signals at predetermined time intervals.

48. The method according to claim 29, further comprising transmitting the beacon signals in response to a request.

49. The method according to claim 29, further comprising transmitting the tag signal in response to a request.

50. The method according to claim 29, wherein the master radio, the beacons and the tag communicate using a wireless communication standard.

51. The method according to claim 29, wherein the master radio, the beacons and the tags communicate using a high level communication standard.

52. The method according to claim 29, wherein the beacons are powered by a battery.

53. The method according to claim 29, wherein the tag is powered by a battery.

54. The method according to claim 29, wherein the master radio is coupled to an antenna.

55. The method according to claim 29, wherein the master radio is coupled to a distributed antenna system.

56. A wireless resource monitoring system for determining the location of a resource deployed in a selected area, comprising:
at least one master radio;
a plurality of beacons being deployed at known positions in the selected area and being in wireless communication with the master radio, the beacons being configured to transmit a beacon signal responsive to instructions from the master radio,
a tag associated with the resource, the tag being configured to receive the beacon signals and operable to measure an attribute of the beacons signals and to transmit a tag signal to the master radio, the tag signal including the identity of the tag, the measured attribute of the beacon signals and the identity of the beacons corresponding to the beacon signals; and
a location processor linked to the master radio, the location processor configured to receive the tag signal from the master radio and operable to determine the location of the resource from the tag signal.

57. The system according to claim 56, wherein the attribute is the signal strength of the beacon signals

58. The system according to claim 56, wherein the location processor includes:
means to identify the location of the beacons from the beacons' identity; and
means to determine beacon-to-tag distances from the measured signal strengths.

59. The system according to claim 58, wherein the location processor includes means to determine a location of the tag from the beacon-to-tag distances and the location of the corresponding beacons.

60. The system according to claim 56, wherein the master radio is a radio transceiver.

61. The system according to claim 56, wherein the beacon is a radio transceiver.

62. The system according to claim 56, wherein the tag is a radio transceiver.

63. The system according to claim 56, further comprising an antenna coupled to the master radio.

64. The system according to claim 56, further comprising a distributed antenna system coupled to the master radio.

65. The system according to claim 56, wherein the beacon is powered by a battery.

66. The system according to claim 56, wherein the tag is powered by a battery.

67. A wireless resource monitoring system for determining the location of a resource in a building, comprising:
at least one master radio;
a plurality of beacons being deployed at known positions in the building and being in wireless communication with the master radio, the beacons being operable to transmit a beacon signal responsive to instructions from the master radio;
a tag associated with the resource, the tag being configured to receive the beacon signals and operable to measure the signal strength of the beacons signals and to transmit a tag signal to the master radio, the tag signal including the identity of the tag, the measured signal strength of the beacon signals and the identity of the beacons corresponding to the beacon signals; and
a location processor linked to the master radio, the location processor configured to receive the tag signal from the master radio and operable to determine the location of the resource in the building from the tag signal.

68. The system according to claim 67, wherein the location processor includes: means to identify a location of the beacons from the beacons' identity; and means to determine beacon-to-tag distances from the measured signal strengths.

69. The system according to claim 68, wherein the location processor includes means to determine a location of the tag from the beacon-to-tag distances and the location of the corresponding beacons.

70. A wireless resource monitoring system for determining the location of a resource deployed in a selected area, comprising:
at least one master radio;
a tag associated with the resource, the tag being configured to transmit a tag signal including the identity of the tag;
a plurality of beacons being deployed at known positions in the selected area and being in wireless communication with the master radio and the tag, the beacons being configured to receive the tag signal and operable to measure an attribute of the tag signal and to transmit a beacon signal to the master radio, the beacon signal including the identity of the transmitting beacon, the measured attribute of the tag signal and the identity of the tag; and
a location processor linked to the master radio, the location processor configured to receive the beacon signal from the master radio and operable to determine the location of the resource from the beacon signal.

71. The system according to claim 70, wherein the attribute is the signal strength of the tag signal.
comparing the highest beacon signal strength value to a predetermined first threshold value; and
